(19) United States
(12) Patent Application Publication
(10) Pub. No.: US 2016/0265238 A1
(43) Pub. Date: Sep. 15, 2016

(54) Support Apparatus

(71) Applicant: David Bruce Brinkman, Denver, CO (US)

(72) Inventor: David Bruce Brinkman, Denver, CO (US)

(21) Appl. No.: 15/158,079

(22) Filed: May 18, 2016

Related U.S. Application Data
(63) Continuation-in-part of application No. 14/604,653, filed on Jan. 23, 2015, now abandoned.

(51) Int. Cl. E04G 3/26; E04G 3/22; F16M 13/02

(52) U.S. Cl. CPC E04G 3/265; F16M 13/02; E04G 3/22

(57) ABSTRACT

A support apparatus for supporting a load on an inclined surface, the support apparatus includes a pair of base extensions removably engaged to the inclined surface, each base extension having first and second end portions, further included is a support platform that includes a plurality of gap forming spaced apart parallel beams that each have proximal and distal end portions, the proximal end portions have a first pivotal attachment to the first end portions. Also, a pair of arms each having a shoulder portion and a strut portion, the shoulder portions have a second pivotal attachment to the distal portions, wherein the strut portions are removably engagable to the second end portions to operationally lock a selected platform angle to the base extensions. Operationally, the platform supports the load with the gaps providing increased lateral grip for the load on the support platform.

### RELATED PATENT APPLICATIONS

This is a continuation in part (CIP) patent application of U.S. patent application Ser. No. 14/604,653 filed on Jan. 23, 2015 by David Bruce Brinkman of Denver, Colo., U.S., that claims the benefit of U.S. provisional patent application Ser. No. 61/930,478 filed on Jan. 23, 2014 by David Bruce Brinkman of Denver, Colo., U.S.

### TECHNICAL FIELD

The present invention relates generally to a support for helping to retain a user, ladder, supplies, or equipment to a surface. More specifically, the present invention relates to the field of roof to roof supports, in having the support help secure the load being defined as the user, ladder, supplies, or equipment to a lower roof surface to assist in keeping the load in a fixed substantially horizontal position upon the lower roof for the user to safely climb upon to stand or place a ladder upon, or secure supplies or equipment for the purpose of performing activities upon subsequently higher building portions.

### BACKGROUND OF INVENTION

Ladder related accidents of a user falling from the ladder typically result in serious injury, wherein serious injury happens in just over half (about 51%) the ladder accidents based on overall ladder injury statistics for the United States. In addition, in higher buildings with steeper pitched roofs the serious injury rate from ladder accidents increases to significantly over half (to about 69%), thus placing the upmost importance on ladder safety for users, as there is really not such a thing as a minor ladder accident, in fact according to the Occupational Safety and Health Administration (OSHA) the leading cause of workplace deaths are construction related falls of which ladders were involved in most of the time.

Overall, based on a recent Consumer Product Safety Commission (CPSC) ladder safety study, ladder related deaths and injuries accounted for almost 700 deaths annually, wherein ladder accidents have increased over 50% in the last decade due mostly to user neglect and negligence in four major areas being; (1) selecting the wrong ladder for the job, (2) using worn or damaged ladders, (3) incorrect use of ladders, and (4) incorrect placement of ladders. It is item (4), the incorrect placement of ladders that the present invention is concerned with, via controlling the base portion positioning of the ladder, as in most cases relying upon surface friction only as between the ladder base portion feet and the ground surface is risky at best. Further, from the CPSC data, the number one cause of ladder accidents at 40% was that the “ladder moved” followed by foot slip at 24%, and lost balance at 18%, after which no other cause of a ladder accident is greater than 4%, resulting that these first three causes of ladder accidents are the most important, thus the most important safety item to remedy is the “ladder moving” cause, which as referenced above alludes to using ladder foot to ground or roof surface friction is a major risk.

The present invention is focused upon the “ladder moved” cause as being the most significant cause of ladder accidents, and specifically focusing on the roof to roof use of a ladder, wherein the ladder feet are on a lower roof with the ladder leaning against an upper roof margin, edge, or building wall portion extending from the roof surface upward. Thus for the present invention, a special interface platform is needed to be developed to help secure the ladder foot to the lower typically angled roof, as opposed to placing the ladder feet upon the angled roof surface.

In looking at the prior art in U.S. Pat. No. 2,320,538 to Vogt disclosed is a roof shingling seat, wherein the seat includes a pair of opposed angle iron base members, a pair of seat bars that are each pivoted to one another at base bars, and a pair of supporting legs that are each pivoted at one end to the free ends of the seat bars, further a seat board is affixed to the seat bars as shown in FIGS. 1 and 2. Vogt further discloses that the supporting legs for the seat are provided at their free ends with apertures that are configured to be removably engaged with mating apertures that are disposed in a longitudinal matter in the base bars, the removable engagement is preferably accomplished by the use of removable pins. Vogt also has cross bracing of the support legs as shown in FIG. 1, the support legs are constructed of angle iron such that the free ends are notched to accommodate the base bars with the free end at the base bars having points that are designed to embed in the roof covering material for anchoring purposes, see FIG. 1. In Vogt, the bars of the assembly are pivoted to the base bars that are also provided with integral pointed hooks for an anchoring engagement to the roof, again as shown in FIG. 1, resulting in the seat being set up for use and retained at the desired position on the angled roof. Vogt also discloses that by removing the pins or fastening elements, the entire structure may be folded into a flattened assembly for storage and transportation. Note that Vogt's only attachment to the angled roof is via the pointed hooks as shown in FIG. 1.

Continuing in the prior art in U.S. Pat. No. 955,159 to Hillmon disclosed a roofing bracket that is similar to Vogt, with Hillmon disclosing a supporting frame consisting of a pair of vertical seat supporting bars pivotally secured at their upper ends at the sides of a seat positioned between the vertical seat supporting bars, pivotally secured to the seat with side rails affixed to each side of the seat. Hillmon also discloses inclined attachment bars pivoted at their upper ends to the side rails including a plurality of openings being formed in attachment bars adjacent to their lower ends terminating in a hooks form upon each opposite end of the attaching bars for engagement with a roof. Further, Hillmon includes studs extending laterally from the lower ends of the vertical seat supporting bars adapted to engage in the openings in the attachment bars, the lower ends of the supporting bars being laterally and inwardly movable to disengage the studs from the openings in the attachment bars, and a horizontal bar connected the supporting bars adapted to prevent the lateral movement of the vertical bars as shown in FIG. 2. Note also that Hillmon's only attachment to the angled roof is via the hooks as shown in FIG. 2.

Next, in the prior art in U.S. Pat. No. 3,866,715 to Foulk discloses a roofing platform is made of three steel frames interconnected to be adjustable for any roof slope and a stage mounted on one of the frames in any of a number of positions for adapting the platform to any roofing slope angle. In Foulk one frame lies against the roof as shown in FIGS. 1 and 2 with a second frame that is generally L-shaped with a vertical riser and a horizontal stage bracket, wherein the bottom of the riser is pivotally connected to the top of the roof frame. Foulk also has a diagonal brace that is pivotally connected to the top of the riser and can be connected to a mid-portion of the roof frame in any of a number of positions so that the riser remains vertical on any roof slope. Foulk also includes spikes on the bottom of the riser that embed in the roof to keep the platform from sliding along the roof angle as best shown in FIGS. 2 and 3. The spikes in Foulk are provided only at the top of the portion engaging the roof such that they can be fitted beneath the flaps of composition shingles and the platform can be used on a completed roof, see FIG. 1. A flat stage in Foulk is mounted on the stage bracket in any of a number of positions forwardly from the roof frame so that the front edge of the stage is quite close to the roof to keep the roofing platform from tipping, again see FIG. 1. Thus Foulk uses the spikes to embed into the roof for securing the roofing platform to the angles roof, as best shown in FIGS. 2 and 3.

Further in the prior art, in U.S. Pat. No. 6,745,869 to Garrett disclosed are a number of roofing accessories, including a lightweight adjustable ladder and scaffold support. The scaffold support in Garrett is provided with a pair of rails spaced apart to match the standard truss frame spacing of most roof joists, wherein connected to the rails through mating suitable holes and slots, are rods supporting an angle adjustable platform. Garrett discloses that one of the rods may be placed through a corresponding slot to achieve a suitable angle of adjustment corresponding to roof incline being similar to a seat back angle adjustment configuration. Further in Garrett, an apparatus is also provided for supporting loads of materials or supplies on an inclined roof, using components and parts in common with the scaffold support apparatus, or components and parts similar thereto. Also in Garrett, a tool tray is provided which may be backed with a layer of foam to prevent the tray from slipping off the roof, while allowing the tray to be freely moved along and up and down the roof, as work progresses. Garrett also shows a pair of ladder feet pivot ends being secured to the support via pins in FIG. 5. Garrett teaches using nails or screws placed through holes 12 directly into a roof frame truss to secure the support to an angled roof.

Continuing in the prior art, in U.S. Pat. No. 8,573,360 to Yoder disclosed a roof jacking seat system that is inclusive of a seat pivotally oriented with respect to a wheeled frame such that the seat can adjust in accommodation of different roof pitch angles. The system in Yoder is for the support of an end user atop of an angled roof during a roof shingle removal processes. The frame in Yoder includes a winching assembly having a cable and hook configuration for removable engagement onto a roof ridge such that the entire system may be driven up or down a side of said roof. The frame in Yoder also includes a plurality of wheels in parallel orientation thereby enabling movement along a single axis up and down the angled roof surface. The pivoting structure enables adjustment of the seat at different angles with respect to the frame, wherein the frame may include along a distal end a footrest for use by the end user.

What is needed is a support for the ladder, the user, and the supplies or equipment on a platform that can accommodate the special interface that is needed to help secure the platform to the angled roof without a permanent attachment and for the platform to accommodate various roof angles. Further, the support needs to be portable via being collapsible in a manner that is lightweight, compact, and easy to install and uninstall on the angled roof surface.

### SUMMARY OF INVENTION

Broadly, the present invention is a support apparatus for supporting a load, wherein the support apparatus is for use on an inclined surface. The support apparatus includes a pair of base extensions, each base extension having a first end portion and an opposing second end portion with a lengthwise axis spanning therebetween. The lengthwise axes are spaced apart and parallel to one another in a juxtapose manner, wherein the base extensions form a first plane as between the lengthwise axes, further each base extension has a longitudinal axis that is positioned perpendicular to both the lengthwise axis and the first plane. Wherein each base extension has a plurality of primary apertures disposed therethrough that are parallel to the longitudinal axis and each base extension second end portion has a plurality of secondary apertures disposed therethrough that are parallel to the first plane.

The support apparatus further includes a support platform that includes a plurality of beams, each beam having a proximal end portion and an opposing distal end portion with an axial axis spanning therebetween, the plurality of axial axes are positioned parallel to one another resulting in the beams oriented parallel to one another in a spaced apart fashion with a gap formed as between a mid-section along the axial axis of each beam. Each gap is defined by a margin periphery formed as between the beams that are adjacent to one another, the plurality of beam proximal end portions have a first pivotal attachment to the base extension first end portions about a first pivotal axis that is perpendicular to the lengthwise axes and positioned as between the spaced apart pair of base extensions. Wherein, the support platform has a first pivotal movement about the first pivotal axis.

The support apparatus additionally includes a pair of arms, each arm having a shoulder portion and an opposing strut end portion with an arm axis spanning therebetween. The arm axes are spaced apart and parallel to one another in a juxtapose manner, wherein the arms form a second plane as between the arm axes. The pair of shoulder portions have a second pivotal attachment to the plurality of beam distal end portions about a second pivotal axis that is perpendicular to the axial axis and parallel to the first pivotal axis, wherein the pair of arms have a second pivotal movement about the second pivotal axis. The pair of strut end portions each have a tertiary aperture that is disposed therethrough each strut end portion, each tertiary aperture is parallel to the first plane wherein a first fastener is received therethrough both the tertiary aperture and the secondary aperture to operationally lock a selected platform angle that is positioned between the axial axis and the lengthwise axis. Further in the support apparatus a plurality of second fasteners utilize the plurality of primary apertures for removably engaging the pair of base extensions to the inclined surface. Wherein operationally the support platform enables the load to be supported on the inclined surface and the margins provide an edge for increased lateral grip for the load on the support platform.

These and other objects of the present invention will become more readily appreciated and understood from a consideration of the following detailed description of the exemplary embodiments of the present invention when taken together with the accompanying drawings, in which;

### BRIEF DESCRIPTION OF DRAWINGS

FIG. 1 shows a perspective view of the support apparatus in an operational positional state, that includes base extensions with the first end portion of the base extension, the second end portion of the base extension, the lengthwise axis, the longitudinal axis, the first plane, with the primary apertures, the secondary apertures, the support platform, the beams, the proximal beam portion, the distal beam portion, the axial axis, the parallel position of the axial axes, the spaced apart fashion of the beams, the gap, the first pivotal attachment, the first pivotal axis, the first pivotal movement, the arms, the shoulder portion of the arm, the strut end portion of the arm, the arm axis, the spaced apart and parallel relationship of the arm axes in a juxtapose manner, the second plane, the second pivotal attachment, the second pivotal axis, the second pivotal movement about the second pivotal axis, the tertiary aperture, the parallel position of the tertiary aperture to the first plane, the first fastener, the selected platform angle, and the second fastener;

FIG. 2 shows a perspective view of the support apparatus in a collapsed or folded up transportation positional state, that includes base extensions with the first end portion of the base extension, the second end portion of the base extension, the first plane, with the primary apertures, the support platform, the beams, the proximal beam portion, the distal beam portion, the axial axis, the spaced apart fashion of the beams, the gap, the midsection of the beam, the margin periphery, the margin edge, the first pivotal attachment, the first pivotal axis, the second pivotal attachment, the second pivotal axis, the perpendicular position of the second pivotal axis to the axial axis, and the parallel position of the second pivotal axis to the first pivotal axis;

FIG. 3 shows a top plan view of FIG. 2 of the support apparatus in the collapsed or folded up transportation positional state, that includes base extensions with the first end portion of the base extension, the second end portion of the base extension, the support platform, the beams, the proximal beam portion, the distal beam portion, the spaced apart fashion of the beams, the gap, the margin periphery, the margin edge, the first pivotal attachment, the first pivotal axis, the second pivotal attachment, the second pivotal axis, and the high friction surface;

FIG. 4 shows an end elevation view of FIG. 1 of the support apparatus in the operational positional state, that includes base extensions with the first end portion of the base extension, the second end portion of the base extension, the first plane, the perpendicular position of the longitudinal axis to the lengthwise axis and the first plane, the support platform, the first pivotal attachment, and the second pivotal attachment;

FIG. 5 shows a side elevation view of FIG. 1 of the support apparatus in the operational positional state at a first selected platform angle, that includes base extensions with the first end portion of the base extension, the second end portion of the base extension, the support platform, the proximal end portion of the beam, the distal end portion of the beam, the first pivotal attachment, the second pivotal attachment, the arm, the shoulder portion of the arm, the strut end portion of the arm, the tertiary aperture, and the first fastener;

FIG. 6 shows a side elevation view of FIG. 1 of the support apparatus in the operational positional state at a second selected platform angle, that includes base extensions with the first end portion of the base extension, the second end portion of the base extension, the support platform, the proximal end portion of the beam, the distal end portion of the beam, the first pivotal attachment, the second pivotal attachment, the arm, the shoulder portion of the arm, the strut end portion of the arm, the tertiary aperture, and the first fastener;

FIG. 7 shows a side elevation view of FIG. 1 of the support apparatus in the operational positional state at a third selected platform angle, that includes base extensions with the first end portion of the base extension, the second end portion of the base extension, the support platform, the proximal end portion of the beam, the distal end portion of the beam, the first pivotal attachment, the second pivotal attachment, the arm, the shoulder portion of the arm, the strut end portion of the arm, the tertiary aperture, and the first fastener;

FIG. 8 shows an in use perspective view of the support apparatus in an operational positional state, wherein the support apparatus utilizes the second fastener for attachment to the inclined surface or lower roof, wherein a user is supported by the support platform using a step ladder with ladder rails, a base end portion of the rails shown, the rungs of the ladder, the perpendicular positioning of the ladder rungs to the rails, the upper roof, the higher building portions, the foot of the user with the user performing work on the higher building portions;

FIG. 9 shows a cross section cut 9-9 from FIG. 8 wherein the ladder and the user are both on the support platform with their foot and shoe plus the base end portion shown to be extending partially into the margin periphery at the margin edge of the gap between the beams, wherein the shoe of the user extending partially into the gap at the margin edge of the margin periphery is for increased lateral grip of the user's shoe to the support platform, also the base end portion of the ladder rail is shown with the base end portion resting upon the support platform at a selected position with the base end portion extending partially into the margin periphery at the margin edge of the gap between the beams, wherein the base end portion extending partially into the gap at the margin edge of the margin periphery is for increased lateral grip of the ladder to the support platform;

FIG. 10 shows another in use perspective view of the support apparatus in an operational positional state, wherein the support apparatus utilizes the second fastener for attachment to the inclined surface or lower roof, giving a user a secure way to ascend a highly inclined roof, the ladder supported by the support platform using a ladder with ladder rails having a perpendicular positioning with the support platform, a base end portion of the rails shown, the rungs of the ladder, the perpendicular positioning of the ladder rungs to the rails, the upper roof, and the higher building portions;

FIG. 11 shows yet another in use perspective view of a pair of the support apparatus in an operational positional state, wherein each support apparatus utilizes the second fastener for attachment to the inclined surface or lower roof, giving a user a secure way to ascend to a highly inclined upper roof, the ladder supported by a planar beam that is suspended as between the pair of support apparatus support platforms using a ladder with ladder rails having a perpendicular positioning with beam from the pair of support platforms, a base end portion of the rails shown, the rungs of the ladder, the perpendicular positioning of the ladder rungs to the rails, the upper roof, and the higher building portions; and

FIG. 12 shows a cross section cut 12-12 from FIG. 9 wherein the ladder and the user are both on the support platform with their foot and shoe plus the base end portion shown to be extending partially into the margin periphery at the margin edge of the gap between the beams, wherein the shoe of the user extending partially into the gap at the margin edge of the margin periphery is for increased lateral grip of the user's shoe to the support platform, also the base end portion of the ladder rail is shown with the base end portion resting upon the support platform at a selected position with the base end portion extending partially into the margin periphery at the margin edge of the gap between the beams, wherein the base end portion extending partially into the gap at the margin edge of the margin periphery is for increased lateral grip of the ladder to the support platform.

### REFERENCE NUMBERS IN DRAWINGS

50 Support apparatus
55 Base extensions
60 First end portion of the base extension 55
65 Second end portion of the base extension 55
70 Lengthwise axis of the base extension 55
75 First plane
80 Longitudinal axis of the base extension 55
85 Perpendicular position of longitudinal axis 80 to the lengthwise axis 70 and the first plane 75
90 Primary apertures
95 Secondary apertures
100 Support platform
105 Beams
110 Proximal end portion of the beam 105
115 Distal end portion of the beam 105
120 Axial axis
125 Parallel position of the axial axes 120
130 Spaced apart fashion of the beams 105
135 Gap that is defined by the pair of opposing 151 margin peripheries 145 and the pair 152 of opposing margin edges 150 forming the omni-directional edge load support 153 in the third plane 154
140 Mid-section of the beam 105
145 Margin periphery
150 Margin edge
151 Pair of opposing margin peripheries 145
152 Pair of opposing margin edges 150
153 Statically fixed pair 151 of margin peripheries 145 and pair 152 of margin edges 150 that form a continuous complete enclosed omni-directional edge load support within the third plane 154
154 Third plane that is disposed in a planar manner within the platform 100
155 First pivotal attachment
160 First pivotal axis
165 First pivotal movement
170 Arms
175 Shoulder portion of the arm 170
180 Strut end portion of the arm 170
185 Arm axis
190 Spaced apart and parallel relationship of the arm axes 185 is a juxtapose manner
195 Second plane
200 Second pivotal attachment
205 Second pivotal axis
210 Perpendicular position of second pivotal axis 205 to the axial axis 120
215 Parallel position of second pivotal axis 205 to first pivotal axis 160
220 Second pivotal movement about the second pivotal axis 205
225 Tertiary aperture
230 Parallel position of tertiary aperture 225 to the first plane 75
235 First fastener
240 Selected platform 100 angle
245 Second fastener
250 Load on support platform 100 that can be for instance the ladder 255, 350 and/or user 310
255 Step ladder
260 Rails for the ladder 225
265 Base end portion of the rails 260
270 Base end portion 265 resting on the support platform 100 at a selected position through the angle 240 via movement 165
275 Base end portion resting on the pair 151 of margin peripheries 145 and the pair 152 of margin edges 150 for increased later grip 326 as against movement 327
280 Rungs of the ladder 255
285 Perpendicular positioning on the ladder 255 rungs 280 to the rails 260
290 Inclined surface
295 Upper roof
300 Lower roof
305 Higher building portions
310 User
315 Foot of user 310
320 Shoe of user 310
325 Shoe of user 310 or base end portion 275, 360 resting on the pair 151 of margin peripheries 145 and the pair 152 of margin edges 150 for increased later grip 326 as against movement 327
326 Increased lateral grip to prevent movement 327 from the pair 151 of margin peripheries 145 and the pair 152 of margin edges 150 as against movement 327
327 Movement within the third plane 154
330 User 310 performing work on higher building portions 305
335 High friction surface on the beams 105
350 Ladder
355 Rails for the ladder 350
360 Base end portion of the rails 355
361 Base end portion 360 resting on the platform 100
362 Base end portion 360 resting on the pair 151 of margin peripheries 145 and the pair 152 of margin edges 150 for increased later grip 326 as against movement 327
365 Base end portion 360 resting on the support platform 100 at a selected position through the angle 240 via movement 165
366 Base end portion 360 resting on the planar beam 390 that is on the support platform 100 at a selected position through the angle 240 via movement 165
370 Base end portion 360 resting on the pair 151 of margin peripheries 145 and the pair 152 of margin edges 150 for increased later grip 326 as against movement 327
375 Rungs of the ladder 350
380 Perpendicular positioning of the ladder 350 rungs 375 to the rails 355
385 Perpendicular positioning of the support platform 100 to the rails 355
390 Planar beam
395 Perpendicular positioning of the beam 390 to the rails 355

### DETAILED DESCRIPTION

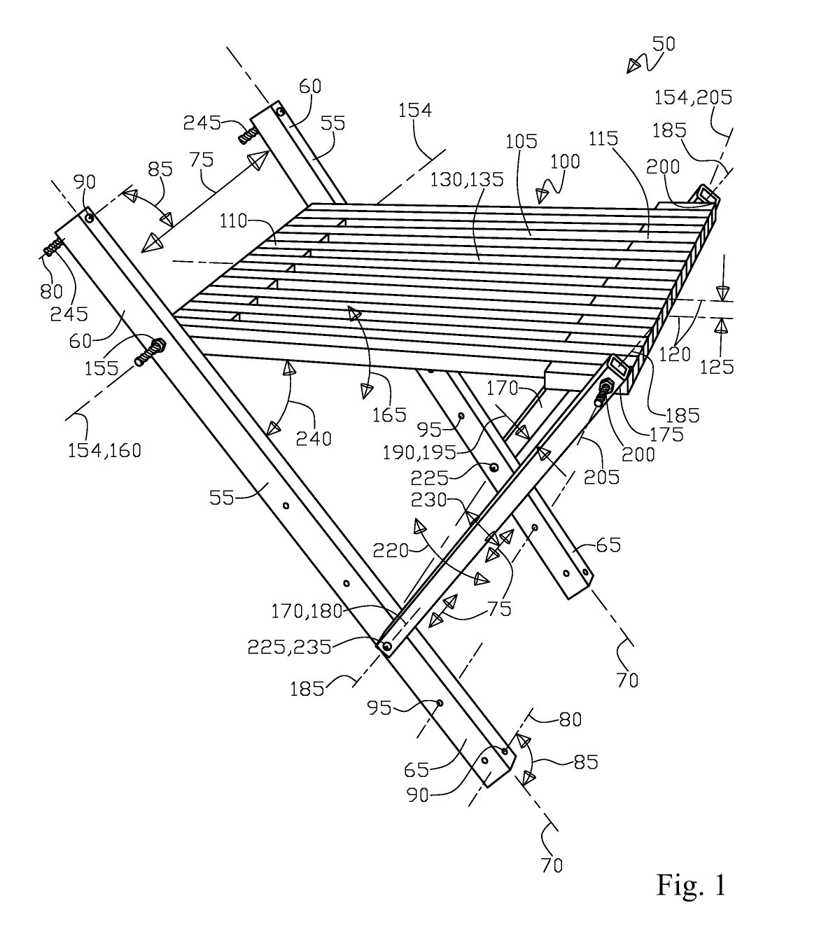

With initial reference to FIG. 1, shown is a perspective view of the support apparatus 50 in an operational positional state, that includes base extensions 55 with the first end portion 60 of the base extension 55, the second end portion 65 of the base extension 55, the lengthwise axis 70, the longitudinal axis 80, and the first plane 75, with the primary apertures 90, the secondary apertures 95, the support platform 100, the beams 105, the proximal beam portion 110, the distal beam portion 115, and the axial axis 120. Also shown in FIG. 1 is the parallel position 125 of the axial axes 120, the spaced apart fashion 130 of the beams 105, the gap 135, the first pivotal attachment 155, the first pivotal axis 160, the first pivotal movement 165, the arms 170, the shoulder portion 175 of the arm 170, the strut end portion 180 of the arm 170, the arm axis 185, the spaced apart and parallel relationship 190 of the arm axes 185 in a juxtapose manner. Continuing in FIG. 1, shown is the second plane 195, the second pivotal attachment 200, the second pivotal axis 205, the second pivotal movement 220 about the second pivotal axis 205, the tertiary aperture 225, the parallel position 230 of the tertiary aperture 225 to the first plane 75, the first fastener 235, the selected platform angle 240, and the second fastener 245.

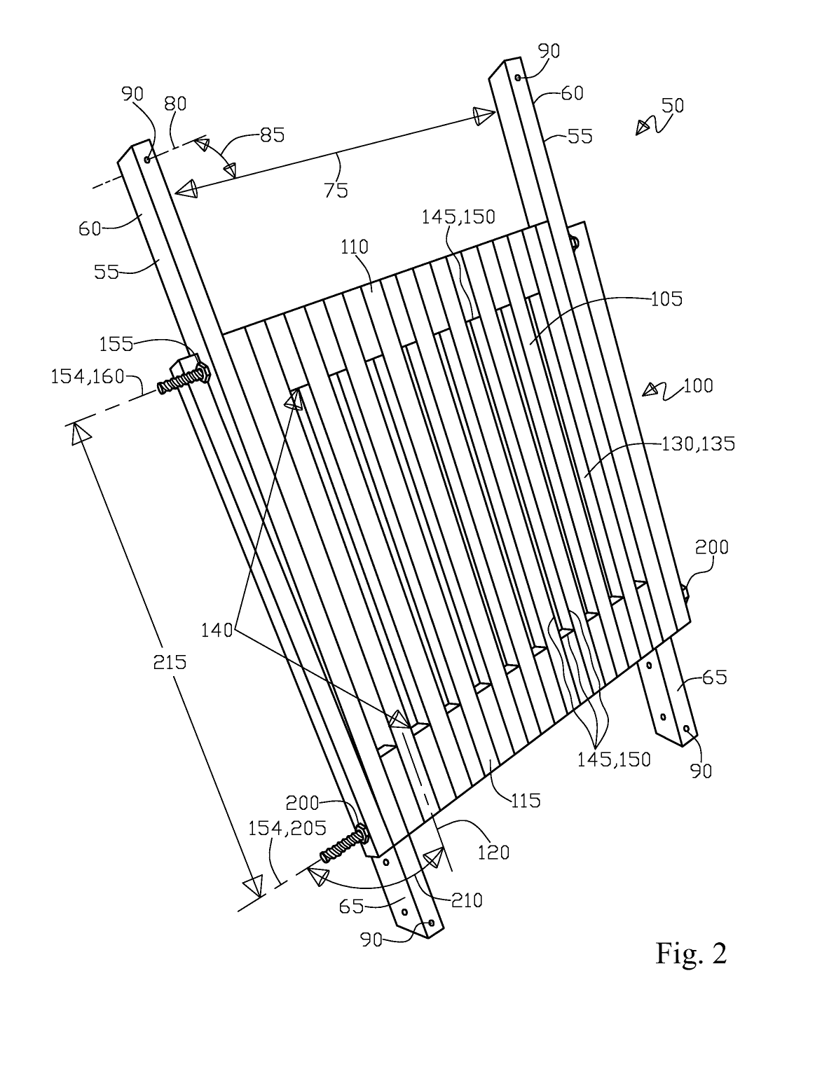

Next, FIG. 2 shows a perspective view of the support apparatus 50 in a collapsed or folded up transportation positional state, that includes base extensions 55 with the first end portion 60 of the base extension 55, the second end portion 65 of the base extension 55, and the first plane 75. In addition, FIG. 2 shows the primary apertures 90, the support platform 100, the beams 105, the proximal beam portion 110, the distal beam portion 115, the axial axis 120, the spaced apart fashion 130 of the beams 105, the gap 135, the midsection 140 of the beam 105, the margin periphery 145, the margin edge 150, the first pivotal attachment 155, the first pivotal axis 160, the second pivotal attachment 200, the second pivotal axis 205, the perpendicular position 210 of the second pivotal axis 205 to the axial axis 120, and the parallel position 215 of the second pivotal axis 205 to the first pivotal axis 160.

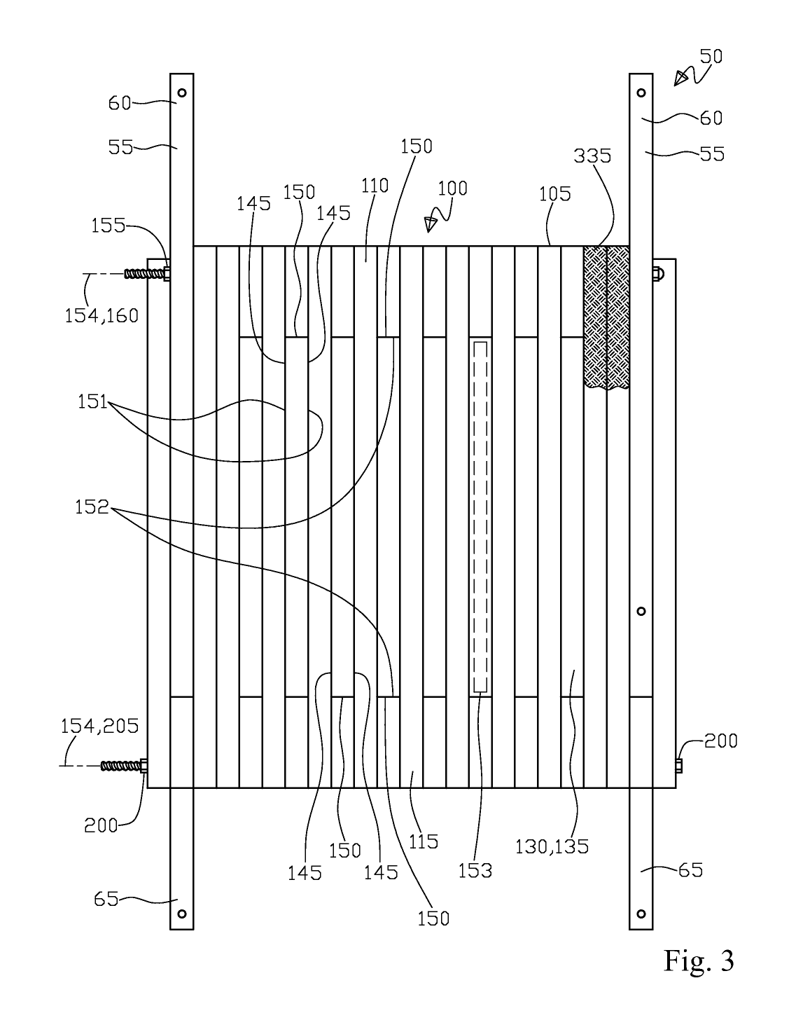

Continuing, FIG. 3 shows a top plan view of FIG. 2 of the support apparatus 50 in the collapsed or folded up transportation positional state, that includes base extensions 55 with the first end portion 60 of the base extension 55, and the second end portion 65 of the base extension 55. Also shown in FIG. 3 is the support platform 100, the beams 105, the proximal beam portion 110, the distal beam portion 115, the spaced apart fashion 130 of the beams 105, the gap 135, the margin periphery 145, the margin edge 150, the first pivotal attachment 155, the first pivotal axis 160, the second pivotal attachment 200, the second pivotal axis 205, and the high friction surface 335.

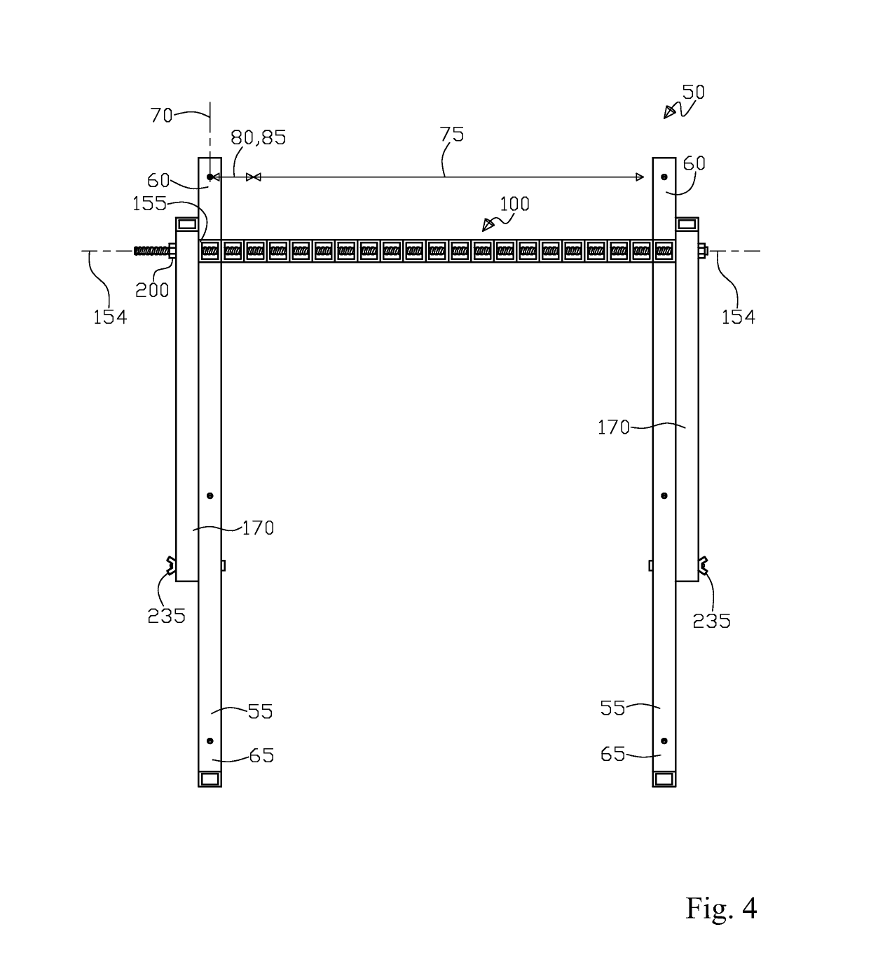

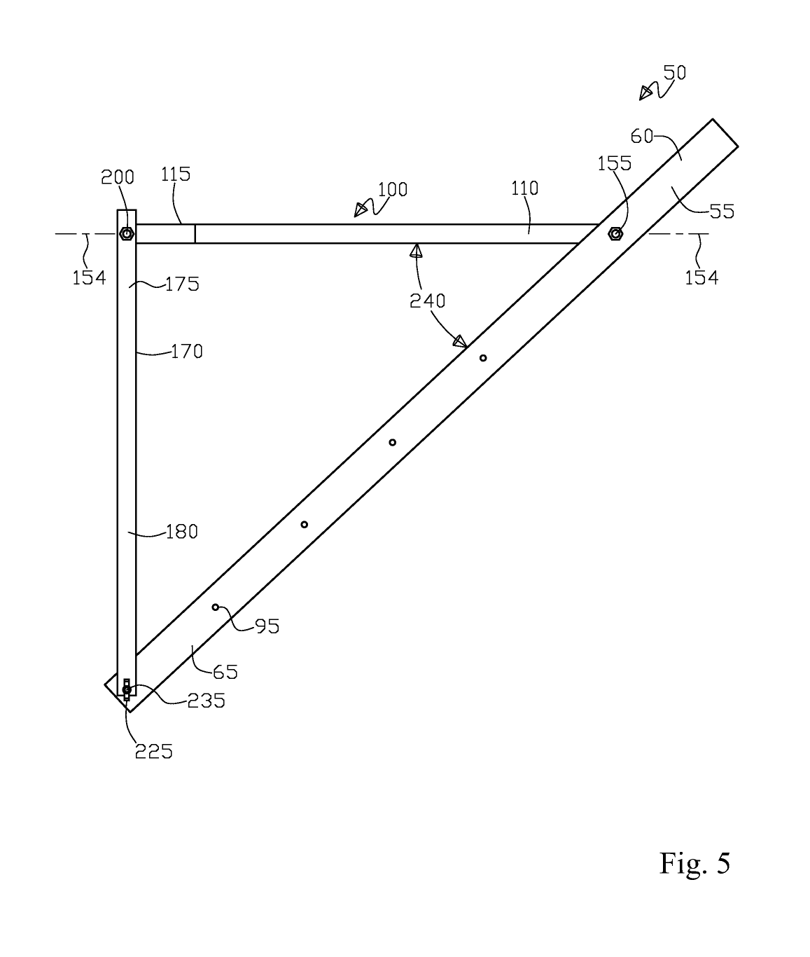

Further, FIG. 4 shows an end elevation view of FIG. 1 of the support apparatus 55 in the operational positional state, that includes base extensions 55 with the first end portion 60 of the base extension 55, the second end portion 65 of the base extension 55, the first plane 75, the perpendicular position 85 of the longitudinal axis 80 to the lengthwise axis 70, and the first plane 75, the support platform 100, the first pivotal attachment 155, and the second pivotal attachment 200. Moving onward, FIG. 5 shows a side elevation view of FIG. 1 of the support apparatus 50 in the operational positional state at a first selected platform angle 240, that includes base extensions 55 with the first end portion 60 of the base extension 55, the second end portion 65 of the base extension 55, the support platform 100, the proximal end portion 110 of the beam 105, the distal end portion 115 of the beam 105, the first pivotal attachment 165, the second pivotal attachment 200, the arm 170, the shoulder portion 175 of the arm 170, the strut end portion 180 of the arm 170, the tertiary aperture 225, and the first fastener 235.

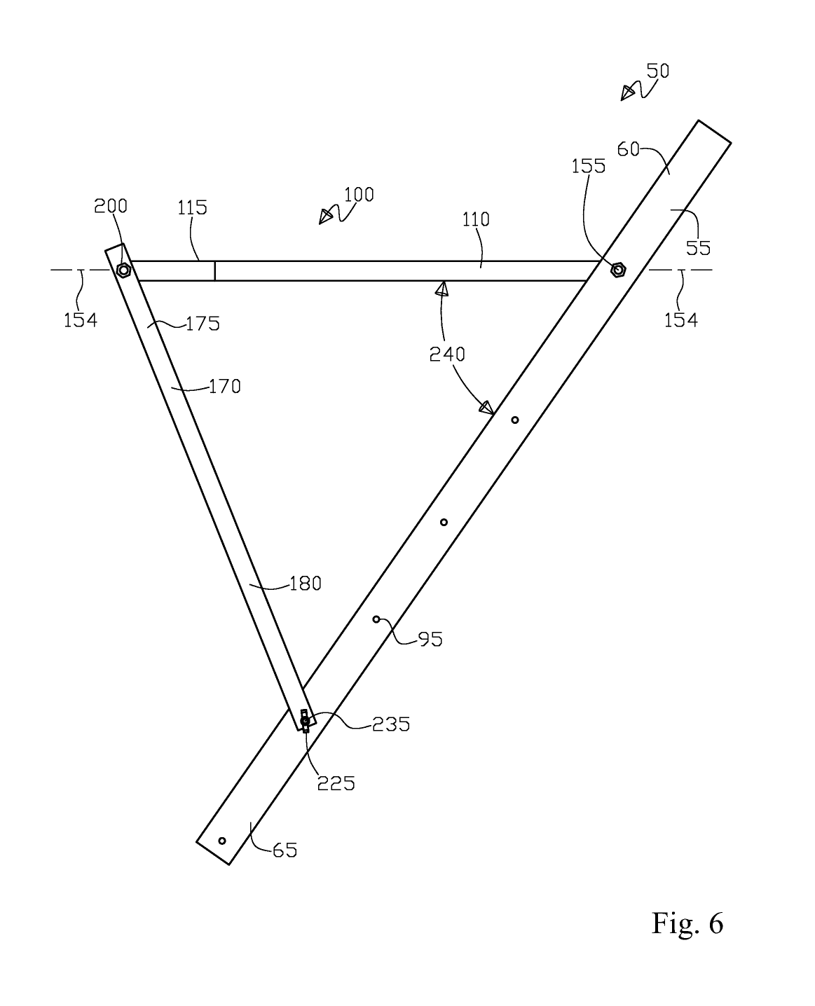

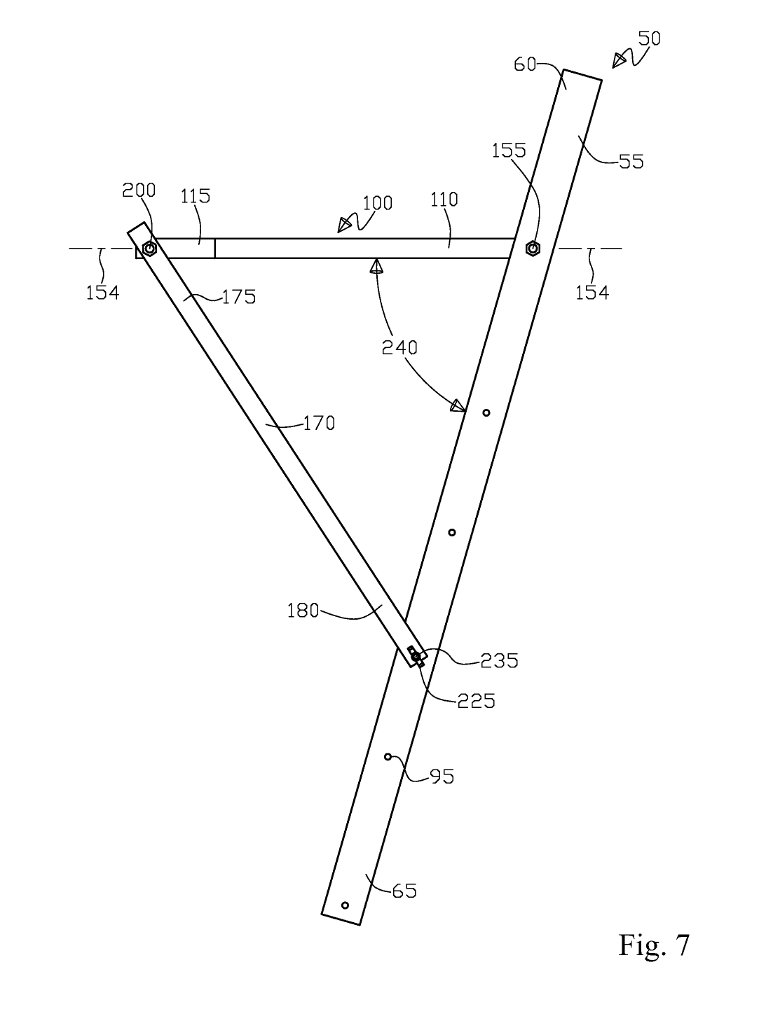

Next, FIG. 6 shows a side elevation view of FIG. 1 of the support apparatus in the operational positional state at a second selected platform angle 240, that includes base extensions 55 with the first end portion 60 of the base extension 55, the second end portion 65 of the base extension 55, the support platform 100, the proximal end portion 110 of the beam 105, the distal end portion 115 of the beam 105, the first pivotal attachment 155, the second pivotal attachment 200, the arm 170, the shoulder portion 175 of the arm 170, the strut end portion 180 of the arm 170, the tertiary aperture 225, and the first fastener 235. Continuing, FIG. 7 shows a side elevation view of FIG. 1 of the support apparatus 50 in the operational positional state at a third selected platform angle 240, that includes base extensions 55 with the first end portion 60 of the base extension 55, the second end portion 65 of the base extension 55, the support platform 100, the proximal end portion 110 of the beam 105, the distal end portion 115 of the beam 105, the first pivotal attachment 165, the second pivotal attachment 200, the arm 170, the shoulder portion 175 of the arm 170, the strut end portion 180 of the arm 170, the tertiary aperture 225, and the first fastener 235.

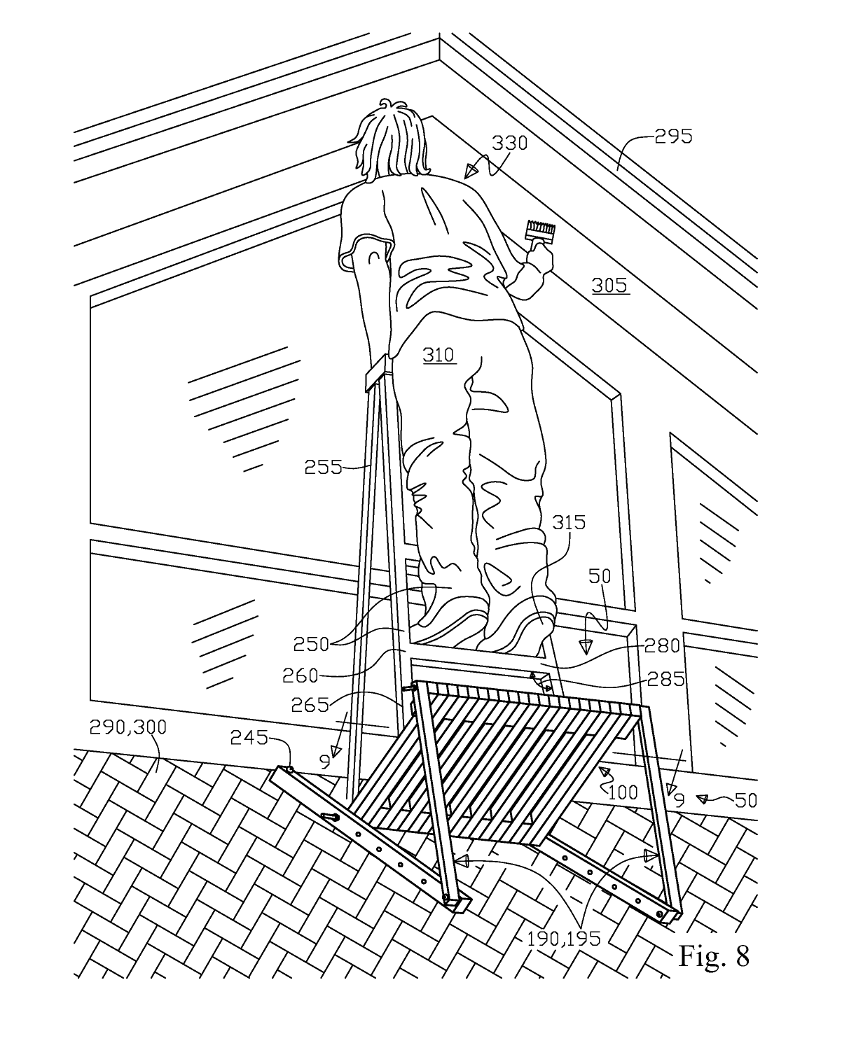

Moving onward, FIG. 8 shows an in use perspective view of the support apparatus 50 in an operational positional state, wherein the support apparatus 50 utilizes the second fastener 245 for attachment to the inclined surface 290 or lower roof 300, wherein a user 310 is supported by the support platform 100 using a ladder 255 with ladder rails 260, a base end portion 265 of the rails 260 shown, the rungs 280 of the step ladder 255, the perpendicular positioning 285 of the ladder rungs 280 to the rails 260, the upper roof 295, the higher building portions 305, the foot 315 of the user 310 with the user 310 performing work 330 on the higher building portions 305.

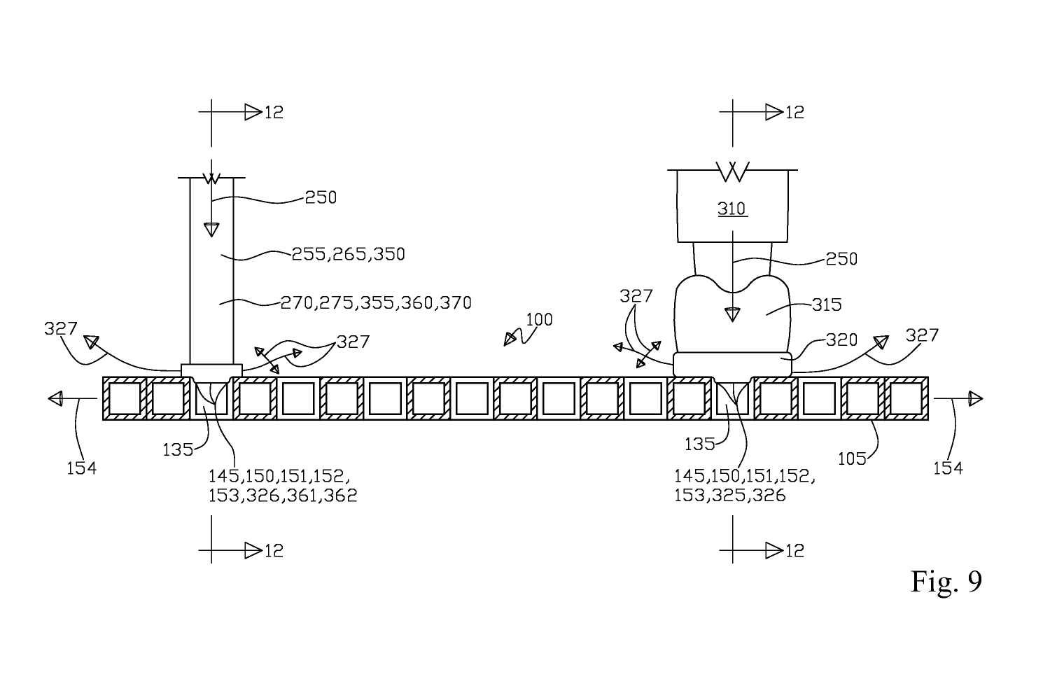

Continuing, FIG. 9 shows a cross section cut 9-9 from FIG. 8 wherein the ladder 255, 350 and the user 310 are on the support platform 100 with their foot 315 and shoe 320 shown to extending partially 325 into the margin periphery 145 at the margin edge 150 of the gap 135 between the beams 105. In addition, FIG. 9 also shows the shoe 320 of the user 310 extending partially 325 into the gap 135 at the margin edge 150 of the margin periphery 145 for increased lateral grip 326 to prevent movement 327 of the user's 310 shoe 320 to the support platform 100. Further, FIG. 9 shows the base end portion 265, 360 of the ladder 255, 350 rail 260, 355 shown with the base end portion 265, 360 resting 270, 361 on the support platform 100 at a selected position with the base end portion 265, 360 extending partially 275, 362 into the margin periphery 145 at the margin edge 150 of the gap 135 between the beams 105, wherein the base end portion 265, 360 is extending partially 275, 362 into the gap 135 at the margin edge 150 of the margin periphery 145 is for increased lateral grip 326 to prevent movement 327 of the ladder 255, 350 to the support platform 100.

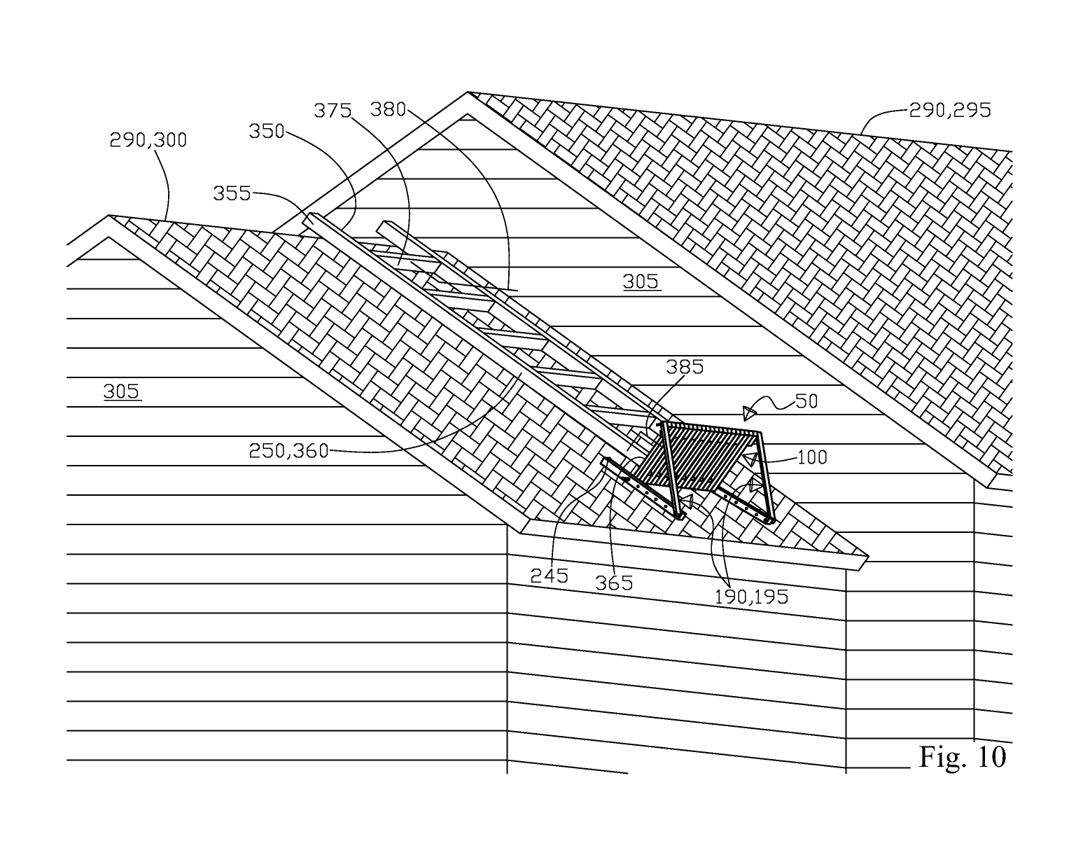

Next, FIG. 10 shows another in use perspective view of the support apparatus 50 in an operational positional state, wherein the support apparatus 50 utilizes the second fastener 245 for attachment to the inclined surface 290 or lower roof 300, giving a user a secure way to ascend a highly inclined roof 295, 300, the ladder 350 supported by the support platform 100 using the ladder 350 with the ladder rails 355 having the perpendicular positioning 385 with the support platform 100, the base end portion 360 of the rails 355 shown, the rungs 375 of the ladder 350, the perpendicular positioning 380 of the ladder 350 rungs 375 to the rails 355, the upper roof 295, and the higher building portions 305.

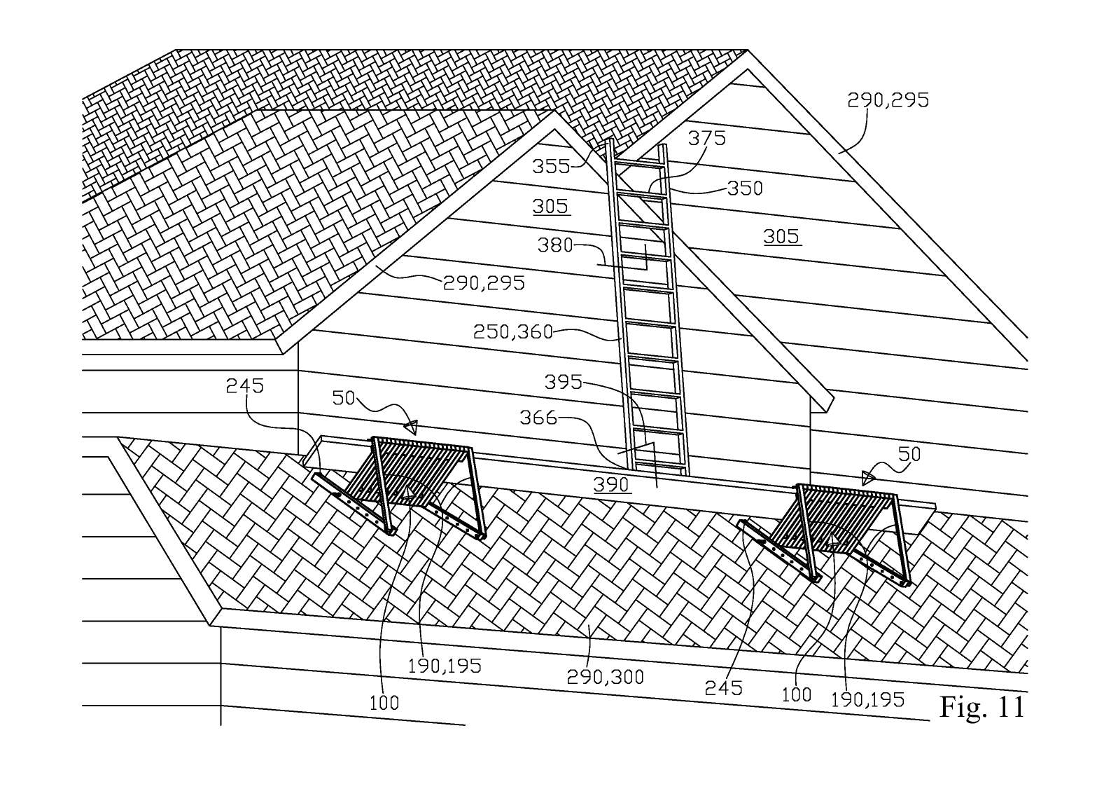

Further, FIG. 11 shows yet another in use perspective view of a pair of the support apparatus 50 in an operational positional state, wherein each support apparatus 50 utilizes the second fastener 245 for attachment to the inclined surface 290 or lower roof 300, giving a user a secure way to ascend to a highly inclined upper roof 295, 300, the ladder 350 supported by a planar beam 390 that is suspended as between the pair of support apparatus 50 support platforms 100 using the ladder 350 with ladder rails 355 having the perpendicular positioning 395 with the beam 390 from the pair of support platforms 100, a base end portion 360 of the rails 355 shown, the rungs 375 of the ladder 350, the perpendicular positioning 380 of the ladder 350 rungs 375 to the rails 355, the upper roof 295, and the higher building portions 305.

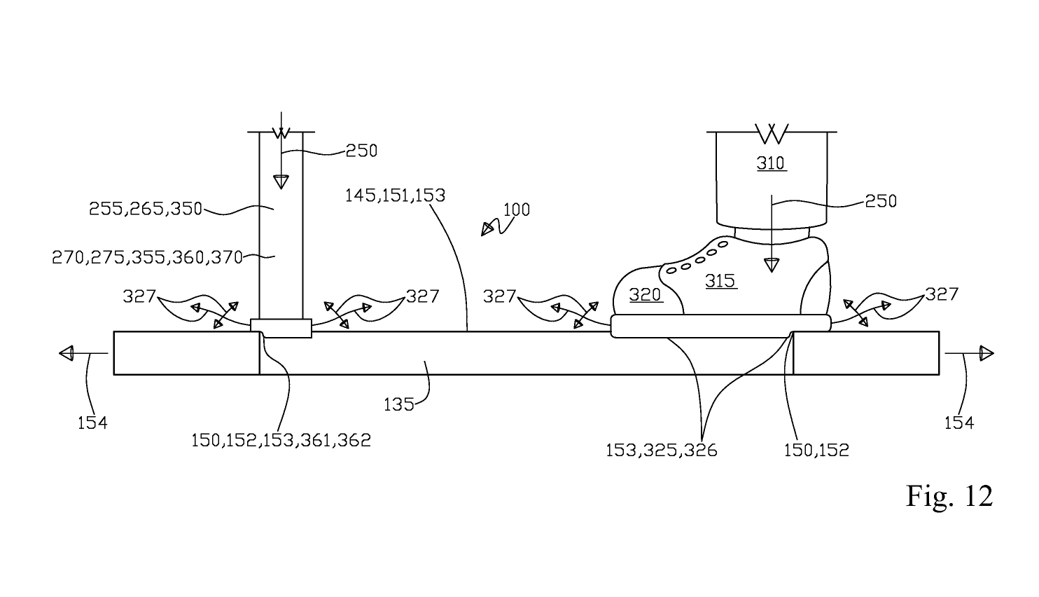

Also, FIG. 12 shows a cross section cut 12-12 from FIG. 9 wherein the ladder 255, 350 and the user 310 are both on the support platform 100 with their foot 315 and shoe 320 plus the base end portion 265, 360 shown to be extending partially into the margin periphery 145 at the margin edge 150 of the gap 135 between the beams 105. FIG. 12 also shows the shoe 210 of the user 310 extending partially into the gap 135 at the margin edge 150 of the margin periphery 145 is for increased lateral grip 326 to prevent movement 327 of the user's 310 shoe 320 to the support platform 100. Also FIG. 12 shows the base end portion of the ladder 255, 350 rail 260, 355 is shown with the base end portion 265, 360 resting 270, 361 upon the support platform 100 at a selected position with the base end portion 265, 360 extending partially 275, 362 into the margin periphery 145 at the margin edge 150 of the gap 135 between the beams 105, wherein the base end portion 265, 360 extending partially 275, 362 into the gap 135 at the margin edge 150 of the margin periphery 145 is for increased lateral grip 326 to prevent movement 327 of the ladder 255, 350 to the support platform 100.

Referring to FIGS. 1 through 7, 9 and 12 the support apparatus 50 is for supporting a load that includes a user 310 or a user 310 and the ladder 255, or other equipment or supplies, wherein the support apparatus 50 is for use on an inclined surface 290, as shown in FIG. 8. The support apparatus 50 includes the pair of base extensions 55, each base extension 55 having the first end portion 60 and the opposing second end portion 65 with the lengthwise axis 70 spanning therebetween, as best shown in FIG. 1. The lengthwise axes 70 are spaced apart and parallel to one another in a juxtapose manner, wherein the base extensions 55 form a first plane 75 as between the lengthwise axes 70, see FIGS. 1 and 2. Further, each base extension 55 has a longitudinal axis 80 that is positioned perpendicular 85 to both the lengthwise axis 70 and the first plane 75, as best shown in FIG. 1. Wherein, each base extension 55 has a plurality of primary apertures 90 disposed therethrough that are parallel to the longitudinal axis 80 and each base extension 55 second end portion 65 has a plurality of secondary apertures 95 disposed therethrough that are parallel to the first plane 75.

Further, referring to FIGS. 1 through 7, 9 and 12 the support apparatus 50 further includes a support platform 100 that includes the plurality of beams 105, each beam 105 having the proximal end portion 110 and the opposing distal end portion 115 with an axial axis 120 spanning therebetween, wherein the plurality of axial axes 120 are positioned parallel 125 to one another resulting in the beams 105 oriented parallel 125 to one another in a spaced apart fashion 130 with a gap 135 formed as between a mid-section 140 along the axial axis 120 of each beam 105, see FIGS. 1, 2, 3, 9, and 12. Each gap 135 is defined by a pair 151 of opposing margin peripheries 145 formed as between the beams 105 that are adjacent to one another, further the gap 135 is also defined by the pair 152 of opposing margin edges 150, wherein the margin peripheries 145, 151 and margin edges 150, 152 form a statically fixed continuous complete enclosed laterally omni-directional edge load support 153 wherein the omni-directional portion is in a third plane 154, the plurality of beam 105 proximal end portions 110 have the first pivotal attachment 155 to the base extension 55 first end portions 50 about the first pivotal axis 160 that is perpendicular to the lengthwise axes 70 and positioned as between the spaced apart pair of base extensions 55, also see FIGS. 1, 2 and 3. Wherein, the support platform 100 has a first pivotal movement 165 about the first pivotal axis 160, see FIG. 1.

Further, looking to FIGS. 1, 5, 6 and 7, the support apparatus 50 additionally includes a pair of arms 170, each arm 170 having the shoulder portion 175 and the opposing strut end portion 180 with an arm axis 185 spanning therebetween, as best shown in FIG. 1. The arm axes 185 are spaced apart 190 and parallel to one another in a juxtapose manner, wherein the arms 170 form a second plane 195 as between the arm axes 185, see FIG. 1. The pair of shoulder portions 175 have a second pivotal attachment 200 to the plurality of beam 105 distal end portions 115 about a second pivotal axis 205 that is perpendicular 210 to the axial axis 120 and parallel to the first pivotal axis 160, wherein the pair of arms 170 have a second pivotal movement 220 about the second pivotal axis 205, as best shown in FIG. 1. The pair of strut end portions 180 each have a tertiary aperture 225 that is disposed therethrough each strut end portion 180, each tertiary aperture 225 is parallel 230 to the first plane 75 wherein a first fastener 235 is received therethrough both the tertiary aperture 225 and the secondary aperture 95 to operationally lock a selected platform 100 angle 240 that is positioned between the axial axis 120 and the lengthwise axis 70, see FIGS. 1, 4, 5, 6, and 7. Further, in the support apparatus 50, a plurality of second fasteners 245 utilize the plurality of primary apertures 90 for removably engaging the pair of base extensions 55 to the inclined surface 290, see FIG. 8. Wherein operationally, the support platform 100 enables the load 250 in the form of the user 310, the ladder 255, or other supplies/materials to be supported on the inclined surface 290 and upon the pair 151 of margin peripheries 145 and pair 152 of margin edges 150 to provide a continuous edge 153 for an increased omni-directional lateral grip 326 to prevent movement 327 for the load 250 upon the support platform 100.

Further, alternatively in referencing FIGS. 10 and 11 for the support apparatus 50 for supporting the load 250 wherein the pair of arms 170 each have an optional elongated distance as between the shoulder portion 175 and the strut end portion 180 to structurally facilitate the selected platform angle 240 up to ninety degrees to operationally allow the load 250 to be parallel to the inclined surface 290 with the support apparatus 50 supporting the load 250 on the inclined surface 290, wherein the inclined surface 290 moves toward vertical.

Also, as an option in referencing FIG. 10 in particular for the support apparatus 50 for supporting the load 250 wherein the pair of arms 170 each have an optional elongated distance as between the shoulder portion 175 and the strut end portion 180 to structurally facilitate the selected platform angle 240 to be ninety degrees or greater to operationally allow the load 250 to be parallel to the inclined surface 290 with the support apparatus 50 supporting the load 250 that is resting on the inclined surface 290.

### CONCLUSION

Accordingly, the present invention of a support apparatus has been described with some degree of particularity directed to the embodiments of the present invention. It should be appreciated, though; that the present invention is defined by the following claim construed in light of the prior art so modifications or changes may be made to the exemplary embodiments of the present invention without departing from the inventive concepts contained therein.

1. A support apparatus for supporting a load, wherein said support apparatus is for use on an inclined surface, comprising:
(a) a pair of base extensions, each said base extension having a first end portion and an opposing second end portion with a lengthwise axis spanning therebetween, said lengthwise axes are spaced apart and parallel to one another in a juxtapose manner, wherein said base extensions form a first plane as between said lengthwise axes, further each said base extension has a longitudinal axis that is positioned perpendicular to both said lengthwise axis and said first plane, wherein each said base extension has a plurality of primary apertures disposed therethrough that are parallel to said longitudinal axis and each said base extension second end portion has a plurality of secondary apertures disposed therethrough that are parallel to said first plane;
(b) a support platform disposed within a third plane in a planar manner, said support platform includes a plurality of beams, each beam having a proximal end portion and an opposing distal end portion with an axial axis spanning therebetween, said plurality of axial axes are positioned parallel to one another resulting in said beams oriented parallel to one another in a spaced apart fashion with a gap formed as between a mid-section along said axial axis of each said beam, each said gap is defined by a pair of opposing margin peripheries formed as between said beams that are adjacent to one another, further said gap is also defined by a pair of opposing margin edges, wherein said margin peripheries and said margin edges form a statically fixed continuous complete enclosed laterally omni-directional edge load support within said third plane, said plurality of beam proximal end portions have a first pivotal attachment to said base extension first end portions about a first pivotal axis that is perpendicular to said lengthwise axes and positioned as between said spaced apart pair of base extensions, wherein said support platform has a first pivotal movement about said first pivotal axis; and
(c) a pair of arms, each said arm having a shoulder portion and an opposing strut end portion with an arm axis spanning therebetween, said arm axes are spaced apart and parallel to one another in a juxtapose manner, wherein said arms form a second plane as between said arm axes, said pair of shoulder portions have a second pivotal attachment to said plurality of beam distal end portions about a second pivotal axis that is perpendicular to said axial axis and parallel to said first pivotal axis, wherein said pair of arms have a second pivotal movement about said second pivotal axis, said pair of strut end portions each have a tertiary aperture that is disposed therethrough each said strut end portion, each said tertiary aperture is parallel to said first plane wherein a first fastener is received therethrough both said tertiary aperture and said secondary aperture to operationally lock a selected platform angle that is positioned between said axial axis and said lengthwise axis, further a plurality of second fasteners utilize said plurality of primary apertures for removably engaging said pair of base extensions to the inclined surface, wherein operationally said support platform enables the load to be supported on the inclined surface and said margin peripheries and said margin edges provide said continuous edge for an increased omni-directional lateral grip in said third plane for the load on said support platform.

2. A support apparatus for supporting a load according to claim 1 wherein said pair of arms each have an elongated distance as between said shoulder portion and said strut end portion to structurally facilitate said selected platform angle up to ninety degrees to operationally allow the load to be parallel to the inclined surface with said support apparatus supporting the load on the inclined surface, wherein the inclined surface moves toward vertical.

3. A support apparatus for supporting a load according to claim 1 wherein said pair of arms each have an elongated distance as between said shoulder portion and said strut end portion to structurally facilitate said selected platform angle to be ninety degrees or greater to operationally allow the load to be parallel to the inclined surface with said support apparatus supporting the load that is resting on the inclined surface.
